(19) United States
(12) Patent Application Publication
(10) Pub. No.: US 2016/0280957 A1
(43) Pub. Date: Sep. 29, 2016

(54) Thermosetting Powder Coating Material and Coated Article

(71) Applicant: FUJI XEROX CO., LTD., Tokyo (JP)

(72) Inventors: Takeshi AGATA, Kanagawa (JP); Masato MIKAMI, Kanagawa (JP); Satoshi YOSHIDA, Kanagawa (JP)

(73) Assignee: FUJI XEROX CO., LTD., Tokyo (JP)

(21) Appl. No.: 14/798,896

(22) Filed: Jul. 14, 2015

(30) Foreign Application Priority Data
Mar. 25, 2015 (JP) 2015-063300

(51) Int. Cl. C09D 167/03

(52) U.S. Cl. CPC C09D 167/03; C08K 9/04

(57) ABSTRACT

A thermosetting powder coating material includes: powder particles containing a thermosetting resin and a thermosetting agent; and inorganic oxide particles containing a silane compound having an amino group.

### CROSS-REFERENCE TO RELATED APPLICATIONS

This application is based on and claims priority under 35 USC 119 from Japanese Patent Application No. 2015-063300 filed Mar. 25, 2015.

### BACKGROUND

1. Technical Field

The present invention relates to a thermosetting powder coating material and a coated article.

2. Related Art

In recent years, since a small amount of volatile organic compounds (VOC) are discharged in a coating step and a powder coating material which is not attached to a material to be coated may be collected and reused after the coating, a powder coating technology using a powder coating material is given attention from the viewpoint of global environment protection. Accordingly, various powder coating materials are being investigated.

### SUMMARY

According to an aspect of the invention, there is provided a thermosetting powder coating material including:

powder particles containing a thermosetting resin and a thermosetting agent; and

inorganic oxide particles containing a silane compound having an amino group.

### DETAILED DESCRIPTION

Hereinafter, exemplary embodiments as examples of the invention will be described in detail.

Thermosetting Powder Coating Material

A thermosetting powder coating material according to the exemplary embodiment (hereinafter, also referred to as a “powder coating material”) includes powder particles containing a thermosetting resin and a thermosetting agent, and inorganic oxide particles (hereinafter, also referred to as a “specific inorganic oxide particle”) containing a silane compound having an amino group.

The powder coating material according to the exemplary embodiment may be any of a transparent powder coating material (clear coating material) not containing a colorant in the powder particles and a colored powder coating material containing a colorant in the powder particles.

Here, in the powder coating material, there is a method of forming a coating film which is excellent in smoothness by using an external additive such as inorganic particles in addition to the powder particles in order to improve fluidity of the powder particles. However, the coating method may be limited depending on the combination of the powder particles and the external additive.

For example, examples of the coating method include an electrostatic powder coating method of performing the coating by utilizing static electricity of the electrified powder particles. As a method of electrifying the powder particles, there are electrification using a corona discharge (referred to as corona-type electrification) and frictional electrification (referred to as tribo type electrification), but due to the difference of electrification methods such as the corona discharge and the frictional electrification, there are some cases where a sufficient amount of the electrification cannot be obtained depending on the type of the powder particles (particularly, a type of a resin present in the powder particles), thus making it difficult to perform the coating.

Meanwhile, the present inventors examined and found that when the powder particles containing a thermosetting resin and inorganic oxide particles containing a silane compound having an amino group (the specific inorganic oxide particle) are combined with each other, triboelectric series of the powder particles and an external additive are controlled and then it is possible to perform the coating with both of the electrification methods.

For this reason, the powder coating material according to the exemplary embodiment may be used in the coating regardless of the coating method, and the fluidity thereof may be improved.

In addition, according to the powder coating material in the exemplary embodiment, the powder coating material has excellent fluidity, and thus it is possible to obtain a coating film in excellent smoothness.

Hereinafter, the powder coating material according to the exemplary embodiment will be described in detail.

The powder coating material according to the exemplary embodiment includes the powder particles and the specific inorganic oxide particles.

Powder Particle

The powder particle includes a thermosetting resin and a thermosetting agent, and, if necessary, a colorant and other additives.

Thermosetting Resin

The thermosetting resin is a resin having a thermosetting reactive group. Examples of the thermosetting resin include various types of the thermosetting resins which are used for the powder particles of the powder coating material in the related art.

The thermosetting resin may be a water-insoluble (hydrophobic) resin. When a water-insoluble (hydrophobic) resin is used as the thermosetting resin, environmental dependence of charging characteristics of the powder coating material (the powder particles) is reduced. In addition, in a case where the powder particles are prepared by an aggregation and coalescence method, also from the viewpoint of realizing emulsification dispersion in an aqueous medium, the thermosetting resin may be a water-insoluble (hydrophobic) resin. Moreover, water-insolubility (hydrophobicity) means that the dissolution amount of an object substance with respect to 100 parts by weight of water at 25° C. is less than 5 parts by weight.

Among the thermosetting resins, the thermosetting polyester resin is preferable from the viewpoint of the easiness of controlling the triboelectric series at the time of coating, the strength of the coating film, and the fine finishing.

Examples of a thermosetting reactive group which is contained in the thermosetting polyester resin include an epoxy group, a carboxyl group, a hydroxyl group, an amide group, an amino group, an acid anhydride group, and a blocked isocyanate group. Among these, the carboxyl group and the hydroxyl group are preferably used from the viewpoint of the easiness of synthesis.

Thermosetting Polyester Resin

The thermosetting polyester resin is, for example, a polycondensate obtained by polycondensating at least a polybasic acid with a polyol.

The introduction of the thermosetting reactive group to the thermosetting polyester resin is performed by adjusting an amount of the polybasic acid and an amount of the polyol to be used in synthesizing the polyester resin. With this adjustment, a thermosetting polyester resin including at least one of a carboxyl group and a hydroxyl group as a thermosetting reactive group is obtained.

In addition, the thermosetting polyester resin may be obtained by introducing the thermosetting reactive group after synthesizing the polyester resin.

Examples of the polybasic acid include terephthalic acid, isophthalic acid, phthalic acid, methyl terephthalic acid, trimellitic acid, pyromellitic acid, and anhydride of these acids; succinic acid, adipic acid, azelaic acid, sebacic acid, and anhydrides of these acids; maleic acid, itaconic acid, and anhydrides of these acids; fumaric acid, tetrahydrophthalic acid, methyltetrahydrophthalic acid, hexahydrophthalic acid, methylhexahydrophthalic acid, or anhydrides of these acids; cyclohexane dicarboxylic acid, 2,6-naphthalene dicarboxylic acid, and the like.

Examples of the polyol include ethylene glycol, diethylene glycol, propylene glycol, dipropylene glycol, 1,3-butane diol, 1,4-butane diol, 1,5-pentane diol, 1,6-hexane diol, neopentyl glycol, triethylene glycol, bis-hydroxyethyl terephthalate, cyclohexane dimethanol, octane diol, diethyl propane diol, butyl ethyl propane diol, 2-methyl-1,3-propane diol, 2,2,4-trimethyl pentane diol, hydrogenated bisphenol A, an ethylene oxide adduct of the hydrogenated bisphenol A, a propylene oxide adduct of the hydrogenated bisphenol A, trimethylolethane, trimethylolpropane, glycerin, pentaerythritol, tris-hydroxy ethyl isocyanurate, hydroxypivalyl hydroxypivalate, and the like.

The thermosetting polyester resin may be obtained by polycondensing a monomer other than the polybasic acid and the polyol.

Examples of the monomer include a compound containing both a carboxyl group and a hydroxyl group in one molecule (for example, dimethanol propionic acid, and hydroxypivalate), a monoepoxy compound (for example, glycidyl ester of a branched aliphatic carboxylic acid such as “Cardura E10” (manufactured by Royal Dutch Shell)), various types of monovalent alcohol (for example, methanol, propanol, butanol, and benzyl alcohol), various types of monobasic acids (for example, benzoic acid, and p-tert-butyl benzoic acid), various types of fatty acids (for example, a castor oil fatty acid, a palm oil fatty acid, and a soybean oil fatty acid), and the like.

The structure of the thermosetting polyester resin may be a branched structure or a linear structure.

It is preferable that the thermosetting polyester resin is the polyester resin having a sum of an acid value and a hydroxyl value of 10 mgKOH/g to 250 mgKOH/g, and the number average molecular weight of 1,000 to 100,000.

When the sum of the acid value and the hydroxyl value is adjusted to be within a range described above, smoothness and mechanical properties of the coating film are easily improved. When the number average molecular weight is adjusted to be within a range described above, the storage stability of the powder coating material as well as the smoothness and mechanical properties of the coating film are easily improved.

Note that, the measurement of the acid value and the hydroxyl value of the thermosetting polyester resin is performed in accordance with JIS K-0070-1992. In addition, the measurement of the number average molecular weight of the thermosetting polyester resin is performed in the same way as that used in the measurement of the number average molecular weight of a thermosetting (meth)acrylic resin described later.

In addition, as the thermosetting resin, the thermosetting (meth)acrylic resin may be used.

Thermosetting (Meth)Acrylic Resin

The thermosetting (meth)acrylic resin is a (meth)acrylic resin including a thermosetting reactive group. For the introduction of the thermosetting reactive group to the (meth)acrylic resin, a vinyl monomer including a thermosetting reactive group may be used. The vinyl monomer including a thermosetting reactive group may be a (meth)acrylic monomer (a monomer containing a (meth)acryloyl group), or may be a vinyl monomer other than the (meth)acrylic monomer.

Examples of the thermosetting reactive group of the thermosetting (meth)acrylic resin include an epoxy group, a carboxyl group, a hydroxyl group, an amide group, an amino group, an acid anhydride group, a (block) isocyanate group, and the like. Among these, as the thermosetting reactive group for the (meth)acrylic resin, at least one type selected from the group consisting of an epoxy group, a carboxyl group, and a hydroxyl group is preferable, from the viewpoint of easiness in preparing the (meth)acrylic resin. Particularly, from the viewpoints of excellent storage stability of the powder coating material and coating film appearance, it is more preferable that at least one type of the thermosetting reactive group is an epoxy group.

Examples of the vinyl monomer including an epoxy group as the thermosetting reactive group include various chain epoxy group-containing monomers (for example, glycidyl (meth)acrylate, β-methyl glycidyl (meth)acrylate, glycidyl vinyl ether, and allyl glycidyl ether), various (2-oxo-1,3-oxolane) group-containing vinyl monomers (for example, (2-oxo-1,3-oxolane) methyl (meth)acrylate), various alicyclic epoxy group-containing vinyl monomers (for example, 3,4-epoxycyclohexyl(meth)acrylate, 3,4-epoxycyclohexylmethyl (meth)acrylate, and 3,4-epoxycyclohexylethyl (meth)acrylate), and the like.

Examples of the vinyl monomer including a carboxyl group as the thermosetting reactive group include various carboxyl group-containing monomers (for example, a (meth)acrylic acid, a crotonic acid, an itaconic acid, a maleic acid, and a fumaric acid), various monoesters of α,β-unsaturated dicarboxylic acid and monohydric alcohol having 1 to 18 carbon atoms (for example, monomethyl fumarate, monoethyl fumarate, monobutyl fumarate, monoisobutyl fumarate, mono-tert-butyl fumarate, monohexyl fumarate, monooctyl fumarate, mono-2-ethylhexyl fumarate, monomethyl maleate, monoethyl maleate, monobutyl maleate, monoisobutyl maleate, mono-tert-butyl maleate, monohexyl maleate, monooctyl maleate, and mono-2-ethylhexyl maleate), monoalkyl ester itaconate (for example, monomethyl itaconate, monoethyl itaconate, monobutyl itaconate, monoisobutyl itaconate, monohexyl itaconate, monooctyl itaconate, and mono-2-ethylhexyl itaconate), and the like.

Examples of the vinyl monomer including a hydroxyl group as the thermosetting reactive group include various hydroxyl group-containing (meth)acrylates (for example, 2-hydroxyethyl (meth)acrylate, 2-hydroxypropyl (meth)acrylate, 3-hydroxypropyl(meth)acrylate, 2-hydroxybutyl (meth)acrylate, 3-hydroxybutyl (meth)acrylate, 4-hydroxybutyl (meth)acrylate, polyethylene glycol mono(meth)acrylate, and polypropylene glycol mono(meth)acrylate), an addition reaction product of the various hydroxyl group-containing (meth)acrylates and ε-caprolactone, various hydroxyl group-containing vinyl ethers (for example, 2-hydroxyethyl vinyl ether, 3-hydroxypropyl vinyl ether, 2-hydroxypropyl vinyl ether, 4-hydroxybutyl vinyl ether, 3-hydroxybutyl vinyl ether, 2-hydroxy-2-methylpropyl vinyl ether, 5-hydroxypentyl vinyl ether, and 6-hydroxyhexyl vinyl ether), an addition reaction product of the various hydroxyl group-containing vinyl ethers and ε-caprolactone, various hydroxyl group-containing allyl ethers (for example, 2-hydroxyethyl (meth)allyl ether, 3-hydroxypropyl (meth)allyl ether, 2-hydroxypropyl (meth)allyl ether, 4-hydroxybutyl (meth)allyl ether, 3-hydroxybutyl (meth)allyl ether, 2-hydroxy-2-methylpropyl (meth)allyl ether, 5-hydroxypentyl (meth)allyl ether, and 6-hydroxyhexyl (meth)allyl ether), an addition reaction product of the various hydroxyl group-containing allyl ethers and ε-caprolactone, and the like.

With respect to the thermosetting (meth)acrylic resin, other vinyl monomers not including a thermosetting reactive group may be copolymerized, in addition to the (meth)acrylic monomer.

Examples of the other vinyl monomer include various α-olefins (for example, ethylene, propylene, and butene-1), various halogenated olefins except for fluoroolefin (for example, vinyl chloride and vinylidene chloride), various aromatic vinyl monomers (for example, styrene, α-methyl styrene, and vinyl toluene), various diesters of unsaturated dicarboxylic acid and monohydric alcohol having 1 to 18 carbon atoms (for example, dimethyl fumarate, diethyl fumarate, dibutyl fumarate, dioctyl fumarate, dimethyl maleate, diethyl maleate, dibutyl maleate, dioctyl maleate, dimethyl itaconate, diethyl itaconate, dibutyl itaconate, and dioctyl itaconate), various acid anhydride group-containing monomers (for example, maleic anhydride, itaconic anhydride, citraconic anhydride, (meth)acrylic anhydride, and tetrahydrophthalic anhydride), various phosphoric acid ester group-containing monomers (for example, diethyl-2-(meth)acryloyloxyethyl phosphate, dibutyl-2-(meth)acryloyloxybutyl phosphate, dioctyl-2-(meth)acryloyloxyethyl phosphate, and diphenyl-2-(meth)acryloyloxyethyl phosphate), various hydrolyzable silyl group-containing monomers (for example, γ-(meth)acryloyloxypropyl trimethoxysilane, γ-(meth)acryloyloxypropyl triethoxy silane, and γ-(meth)acryloyloxypropyl methyldimethoxysilane), various aliphatic vinyl carboxylate (for example, vinyl acetate, vinyl propionate, vinyl butyrate, vinyl isobutylate, vinyl caproate, vinyl caprylate, vinyl caprate, vinyl, laurate, branched aliphatic vinyl carboxylate having 9 to 11 carbon atoms, and vinyl stearate), various vinyl esters of carboxylic acid having a cyclic structure (for example, vinyl cyclohexane carboxylate, vinyl methylcyclohexane carboxylate, vinyl benzoate, and vinyl p-tert-butyl benzoate), and the like.

In the thermosetting (meth)acrylic resin, in the case of using a vinyl monomer other than the (meth)acrylic monomer, as the vinyl monomer including a thermosetting reactive group, an acrylic monomer not including a thermosetting reactive group is used.

Examples of the acrylic monomer not including a thermosetting reactive group include alkyl ester (meth)acrylate (for example, methyl (meth)acrylate, ethyl (meth)acrylate, n-propyl (meth)acrylate, isopropyl (meth)acrylate, n-butyl(meth)acrylate, isobutyl (meth)acrylate, tert-butyl (meth)acrylate, n-hexyl (meth)acrylate, cyclohexyl (meth)acrylate, 2-ethylhexyl (meth)acrylate, n-octyl (meth)acrylate, isooctyl (meth)acrylate, 2-ethyloctyl (meth)acrylate, dodecyl (meth)acrylate, isodecyl (meth)acrylate, lauryl (meth)acrylate, and stearyl (meth)acrylate), various aryl ester (meth)acrylates (for example, benzyl (meth)acrylate, phenyl (meth)acrylate, and phenoxyethyl (meth)acrylate), various alkyl carbitol (meth)acrylates (for example, ethyl carbitol (meth)acrylate), other various (meth)acrylate esters (for example, isobornyl (meth)acrylate, dicyclopentanyl (meth)acrylate, dicyclopentenyl(meth)acrylate, dicyclopentenyloxyethyl(meth)acrylate, and tetrahydrofurfuryl (meth)acrylate), various amino group-containing amide unsaturated monomers (for example, N-dimethylaminoethyl (meth)acrylamide, N-diethylaminoethyl (meth)acrylamide, N-dimethylaminopropyl (meth)acrylamide, and N-diethylamino propyl (meth)acrylamide), various dialkylaminoalkyl (meth)acrylates (for example, dimethylaminoethyl (meth)acrylate and diethylaminoethyl (meth)acrylate), various amino group-containing monomers (for example, tert-butylaminoethy (meth)acrylate, tert-butylaminopropyl (meth)acrylate, aziridinylethyl (meth)acrylate, pyrrolidinylethyl (meth)acrylate, and piperidinylethyl (meth)acrylate), and the like.

A number average molecular weight of the thermosetting (meth)acrylic resin is preferably from 1,000 to 20,000 (more preferably from 1,500 to 15,000).

When the number average molecular weight thereof is in the range described above, smoothness and mechanical properties of the coating film are easily improved.

The number average molecular weight of the thermosetting (meth)acrylic resin is measured by gel permeation chromatography (GPC). The molecular weight measurement by GPC is performed with a THF solvent using HLC-8120, a GPC manufactured by Tosoh Corporation as a measurement device and TSKgel Super HM-M (15 cm), a column manufactured by Tosoh Corporation. The weight average molecular weight and the number average molecular weight are calculated using a calibration curve of molecular weight obtained with a monodisperse polystyrene standard sample from results of this measurement.

The thermosetting resin may be used alone or in combination of two or more types thereof.

The content of the thermosetting resin is preferably from 20% by weight to 99% by weight, and more preferably from 30% by weight to 95% by weight, with respect to the entirety of the powder particles.

In addition, as described later, when the powder particle is the core/shell type particle, in a case where the thermosetting resin is used as the resin of the resin coating portion, the content of the thermosetting resin represents the content of the entire thermosetting resin of the core and the resin coating portion.

Thermosetting Agent

The thermosetting agent is selected depending on the types of the thermosetting reactive group of the thermosetting resin.

Here, the thermosetting agent means a compound having a functional group which is reactive to the thermosetting reactive group which is a terminal group of the thermosetting resin.

When the thermosetting reactive group of the thermosetting resin is a carboxyl group, specific examples of the thermosetting agent include various epoxy resins (for example, polyglycidylether of bisphenol A), an epoxy group-containing acrylic resin (for example, glycidyl group-containing acrylic resin), various polyols (for example, 1, 6-hexanediol, trimethylol propane, and trimethylol ethane), various polyglycidylesters of polycarboxylic acid (for example, a phthalic acid, a terephthalic acid, an isophthalic acid, a hexahydrophthalic acid, a methyl hexahydrophthalic acid, a trimellitic acid, and a pyromellitic acid), various alicyclic epoxy group-containing compounds (for example, bis(3, 4-epoxy cyclohexyl) methyl adipate), hydroxy amide (for example, triglycidylisocyanurate and β-hydroxyalkyl amide), and the like.

When the thermosetting reactive group of the thermosetting resin is a hydroxyl group, examples of the thermosetting agent include blocked polyisocyanate, aminoplast, and the like. Examples of blocked polyisocyanate include organic diisocyanate such as various aliphatic diisocyanates (for example, hexamethylene diisocyanate and trimethyl hexamethylene diisocyanate), various alicyclic diisocyanates (for example, xylylene diisocyanate and isophozone diisocyanate), various aromatic diisocyanates (for example, tolylene diisocyanate and 4,4′-diphenylmethane diisocyanate); an adduct of the organic diisocyanate and polyol, a low-molecular weight polyester resin (for example, polyester polyol), or water; a polymer of the organic diisocyanate (a polymer including isocyanurate-type polyisocyanate compound); various polyisocyanate compounds blocked by a commonly used blocking agent such as isocyanate biuret product; a self-block polyisocyanate compound having a uretdione bond in a structural unit; and the like.

When the thermosetting reactive group of the thermosetting resin is an epoxy group, examples of the thermosetting agent include acids such as succinic acid, glutaric acid, adipic acid, pimelic acid, suberic acid, azelaic acid, sebacic acid, dodecanedioic acid, eicosanoic diacid, maleic acid, citraconic acid, itaconic acid, glutaconic acid, phthalic acid, trimellitic acid, pyromellitic acid, tetrahydrophthalic acid, hexahydrophthalic acid, and cyclohexene-1,2-dicarboxylic acid; anhydrides thereof; urethane-modified products thereof; and the like. Among these, as the thermosetting agent, the aliphatic dibasic acid is preferable from the viewpoints of physical properties of the coating film and storage stability, and dodecanedioic acid is particularly preferable from the viewpoint of physical properties of the coating film.

The thermosetting agent may be used alone or in combination of two or more types thereof.

The content of the thermosetting agent is preferably from 1% by weight to 30% by weight and more preferably from 3% by weight to 20% by weight, with respect to the thermosetting resin.

Meanwhile, as described later, the powder particle is the core/shell type resin particle, when the thermosetting resin is used as the resin of the resin coating portion, the content of the thermosetting agent means the content of the thermosetting agent with respect to the entire content of the thermosetting resin in the core and the resin coating portion.

Colorant

As a colorant, a pigment is used, for example. As the colorant, a pigment and a dye may be used in combination.

Examples of the pigment include an inorganic pigment such as iron oxide (for example, colcothar), titanium oxide, titanium yellow, zinc white, white lead, zinc sulfide, lithopone, antimony oxide, cobalt blue, and carbon black; an organic pigment such as quinacridone red, phthalocyanine blue, phthalocyanine green, permanent red, Hansa yellow, indanthrene Blue, Brilliant Fast Scarlet, and benzimidazolones yellow; and the like.

In addition, as the pigment, a brilliant pigment is also used. Examples of the photoluminescent pigment include metal powder such as a pearl pigment, aluminum powder, stainless steel powder; metallic flakes; glass beads; glass flakes; mica; and flake-like phosphorus iron oxide (MIO).

The colorant may be used alone or in combination of two or more kinds thereof.

The content of the colorant is determined depending on types of the pigment, and the hue, brightness, and the depth acquired for the coating film.

The content of the colorant is, for example, preferably from 1% by weight to 70% by weight and more preferably from 2% by weight to 60% by weight, with respect to the entire resin which forms the powder particles.

Di- or Higher-Valent Metal Ions

The powder particle preferably contains di- or higher-valent metal ions (hereinafter, simply referred to as “metal ions”). As described later, when the powder particle is the core/shell type particle, the metal ions are components contained in both the core and the resin coating portion of the powder particle.

When di- or higher-valent metal ions are contained in the powder particle, ion crosslinking is formed in the powder particle by the metal ions. For example, when the thermosetting polyester resin is used as the thermosetting resin, a carboxyl group or a hydroxyl group of the thermosetting polyester resin interacts with the metal ions and the ion crossliinking is formed. With this ion crosslinking, a phenomenon (so called, “bleed”) in which inclusions (a thermosetting agent, a colorant added if necessary, in addition to the thermosetting agent, or other additives) in the powder particles are deposited on the surface of powder particles is prevented and thus it is likely that storage properties are improved. In addition, after coating with the powder coating material, the bond of the ion crosslinking is broken due to heating at the time of thermal curing, and accordingly, the melt viscosity of the powder particles decreases and a coating film having excellent smoothness is easily formed.

Examples of the metal ions include divalent to tetravalent metal ions. Specifically, as the metal ions, at least one type of metal ion selected from the group consisting of an aluminum ion, a magnesium ion, an iron ion, a zinc ion, and a calcium ion is used.

As a supply source of the metal ion (compound added to the powder particles as an additive), metal salt, an inorganic metal salt polymer, a metal complex, and the like are used, for example. For example, when preparing the powder particles by an aggregation and coalescence method, the metal salt and the inorganic metal salt polymer are added to the powder particles as an aggregating agent.

Examples of the metal salt include aluminum sulfate, aluminum chloride, magnesium chloride, magnesium sulfate, iron (II) chloride, zinc chloride, calcium chloride, calcium sulfate, and the like.

Examples of the inorganic metal salt polymer include polyaluminum chloride, polyaluminum hydroxide, iron (II) polysulfate, calcium polysulfide, and the like.

Examples of the metal complex include metal salt of an aminocarboxylic acid and the like. Specific examples of the metal complex include a metal salt (for example, calcium salt, magnesium salt, iron salt, and aluminum salt) containing a well known chelate as a base, such as ethylenediamine tetraacetic acid, propanediamine tetraacetic acid, nitrilotriacetic acid, triethylenetetramine hexaacetic acid, diethylenetriamine pentacetic acid, and the like.

Such a supply source of the metal ions may not be used as an aggregating agent, but may be added simply as an additive.

As the valence of the metal ions is high, mesh ion crosslinking is easily formed, and a high valence metal is preferable from the viewpoints of smoothness of the coating film and the storage properties of the powder coating material. Accordingly, the metal ion is preferably an Al ion. That is, as the supply source of the metal ion, an aluminum salt (for example, aluminum sulfate or aluminum chloride) or an aluminum salt polymer (for example, polyaluminum chloride or polyaluminum hydroxide) is preferable. Among the supply sources of the metal ions, the inorganic metal salt polymer is preferable, compared to the metal salt, even though the valences of the metal ions thereof are the same as each other, from the viewpoints of smoothness of the coating film and the storage properties of the powder coating material. Accordingly, the supply source of the metal ions is particularly preferably an aluminum salt polymer (for example, polyaluminum chloride or polyaluminum hydroxide).

The content of the metal ions is preferably from 0.002% by weight to 0.2% by weight and more preferably from 0.005% by weight to 0.15% by weight, with respect to the entire powder particles, from the viewpoints of smoothness of the coating film and the storage properties of the powder coating material.

When the content of the metal ions is equal to or greater than 0.002% by weight, suitable ion crosslinking is formed by the metal ions, bleeding of the powder particles is prevented, and the storage properties of the powder coating material are easily improved. Meanwhile, when the content of the metal ions is equal to or smaller than 0.2% by weight, the formation of excessive ion crosslinking by the metal ions is prevented, and the smoothness of the coating film is easily improved.

Herein, when preparing the powder particles by an aggregation and coalescence method, the supply source of the metal ions added as an aggregating agent (metal salt or metal salt polymer) contributes to controlling the particle diameter distribution and shapes of the powder particles.

Specifically, high valence of the metal ions is preferable, in order to obtain a narrow particle diameter distribution. In addition, in order to obtain a narrow particle diameter distribution, the metal salt polymer is preferable, compared to the metal salt, even though the valences of the metal ions thereof are the same as each other. Accordingly, from the viewpoints described above, the supply source of the metal ions is preferably aluminum salt (for example, aluminum sulfate or aluminum chloride) and an aluminum salt polymer (for example, polyaluminum chloride or polyaluminum hydroxide), and particularly preferably an aluminum salt polymer (for example, polyaluminum chloride or polyaluminum hydroxide).

When the aggregating agent is added so that the content of the metal ion is equal to or greater than 0.002% by weight, aggregation of the resin particles in the aqueous medium proceeds, and this contributes to realization of the narrow particle diameter distribution. The aggregation of the resin particles to be the resin coating portion proceeds compared with the aggregated particles to be the core, and this contributes to realization of the formation of the resin coating portion with respect to the entire surface of the core. Meanwhile, when the aggregating agent is added so that the content of the metal ions is equal to or smaller than 0.2% by weight, the excessive formation of ion crosslinking in the aggregated particles is prevented, and the shape of the powder particles generated when performing coalescence is easily set to be close to a sphere. Accordingly, from the viewpoints described above, the content of the metal ions is preferably from 0.002% by weight to 0.2% by weight and more preferably from 0.005% by weight to 0.15% by weight.

The content of the metal ion is measured by quantitative analysis of fluorescent X-ray intensity of the powder particles. Specifically, for example, first a resin and a supply source of the metal ions are mixed with each other, and a resin mixture having a predetermined concentration of the metal ions is obtained. A pellet sample is obtained with 200 mg of this resin mixture by using a tablet molding tool having a diameter of 13 mm. The weight of this pellet sample is precisely weighed, and the fluorescent X-ray intensity of the pellet sample is measured to obtain peak intensity. In the same manner as described above, the measurement is performed for the pellet samples in which the added amount of the supply source of the metal ions is changed, and a calibration curve is prepared with the results. The quantitative analysis of the content of the metal ions in the powder particles to be a measurement target is performed by using this calibration curve.

Examples of a method of adjusting the content of the metal ions include 1) a method of adjusting the added amount of the supply source of the metal ions, 2) in a case of preparing the powder particles by an aggregation and coalescence method, a method of adjusting the content of the metal ions by adding the aggregating agent (for example, metal salt or the metal salt polymer) as the supply source of the metal ions in an aggregation step, adding a chelating agent (for example, ethylenediamine tetraacetic acid (EDTA), diethylenetriamine pentacetic acid (DTPA), or nitrilotriacetic acid (NTA)) at a last stage of the aggregation step to form a complex with the metal ions by the chelating agent, and removing the formed complex salt in a washing step.

Other Additive

As the other additive, various additives used in the powder coating material are used.

Specific examples of the other additive include a foam inhibitor (for example, benzoin or benzoin derivatives), a hardening accelerator (an amine compound, an imidazole compound, or a cationic polymerization catalyst), a surface adjusting agent (a leveling agent), a plasticizer, a charge-controlling agent, an antioxidant, a pigment dispersant, a flame retardant, a fluidity-imparting agent, and the like.

Core/Shell Type Particle

In the exemplary embodiment, the powder particle may be the core/shell type particle including the core containing the thermosetting resin and the thermosetting agent, and the resin coating portion which coat a the surface of the core.

At this time, the core may contain the colorant and other additives described above in addition to the thermosetting resin and the thermosetting agent, as necessary.

In addition, the resin coating portion in the core/shell type particle will be described below.

The resin coating portion may be configured only of a resin, or may include other components (the thermosetting agent described as components for the core, or other additives).

Here, the resin coating portion is preferably configured to contain only a resin, in order to reduce the bleed. Even when the resin coating portion includes components other than the resin, the content of the resin may be equal to or greater than 90% by weight (preferably equal to or greater than 95% by weight) with respect to the entire resin coating portion.

The resin of the resin coating portion may be a non-curable resin, or may be a thermosetting resin. However, the resin of the resin coating portion is preferably a thermosetting resin, in order to improve curing density (crosslinking density) of the coating film.

When the thermosetting resin is used as the resin of the resin coating portion, as this thermosetting resin, the same thermosetting resin used for the thermosetting resin of the core is used and the same is true for the preferable example. However, the thermosetting resin of the resin coating portion may be the same type of the resin as the thermosetting resin of the core or may be a different resin.

When the non-curable resin is used as the resin of the resin coating portion, the non-curable resin is preferably at least one type selected from the group consisting of an acrylic resin and a polyester resin.

The coverage of the resin coating portion is preferably from 30% to 100% and more preferably from 50% to 100%, in order to prevent bleeding.

The coverage of the resin coating portion with respect to the surface of the powder particle is a value obtained by X-ray photoelectron spectroscopy (XPS) measurement.

Specifically, in the XPS measurement, JPS-9000MX manufactured by JEOL Ltd. is used as a measurement device, and the measurement is performed by using an MgKα ray as the X-ray source and setting an accelerating voltage to 10 kV and an emission current to 30 mA.

The coverage of the resin coating portion with respect to the surface of the powder particles is determined by peak separation of a component derived from the material of the core on the surface of the powder particles and a component derived from a material of the resin coating portion, from the spectrum obtained under the conditions described above. In the peak separation, the measured spectrum is separated into each component using curve fitting by the least square method.

As the component spectrum to be a separation base, the spectrum obtained by singly measuring the thermosetting resin, a curing agent, a pigment, an additive, and a coating resin, respectively, which is used in preparation of the powder particles, is used. In addition, the coverage is acquired from a ratio of a spectral intensity derived from the coating resin with respect to the total of entire spectral intensity obtained from the powder particles.

The thickness of the resin coating portion is preferably from 0.2 μm to 4 μm and more preferably from 0.3 μm to 3 μm, in order to prevent bleeding.

The thickness of the resin coating portion is a value obtained by the following method. The powder particles are embedded in the epoxy resin, and a sliced piece is prepared by performing cutting with a diamond knife. This sliced piece is observed using a transmission electron microscope (TEM) and plural of images of the cross section of the powder particles are imaged. The thicknesses of 20 portions of the resin coating portion are measured from the images of the cross section of the powder particles, and an average value thereof is used. When it is difficult to observe the resin coating portion in the image of the cross section due to a clear powder coating material, it is possible to easily perform the measurement by performing dyeing and observation.

Preferable Properties of Powder Particles

Volume Average Particle Diameter Distribution Index GSDv

In the exemplary embodiment, the volume average particle diameter distribution index GSDv of the powder particles is preferably equal to or less than 1.50, more preferably equal to or less than 1.40, even more preferably equal to or less than 1.30, in terms of the smoothness of the coating film, and the storage properties of the powder coating material.

Volume Average Particle Diameter D50v

In addition, the volume average particle diameter D50v of the powder particles is preferably from 1 μm to 25 μm, more preferably from 2 μm to 20 μm, and most preferably from 3 μm to 15 μm, forming the coating film which is excellent in the smoothness with a small amount thereof.

Average Circularity

Furthermore, the average circularity of the powder particles is preferably equal to or greater than 0.96, more preferably equal to or greater than 0.97, and even more preferably equal to or greater than 0.98, in terms of the smoothness of the coating film, and the storage properties of the powder coating material.

Here, the volume average particle diameter D50v and the volume average particle diameter distribution index GSDv of the powder particles are measured using a Multisizer II (manufactured by Beckman Coulter, Inc.) and ISOTON-II (manufactured by Beckman Coulter, Inc.) as an electrolyte.

In the measurement, from 0.5 mg to 50 mg of a measurement sample is added to 2 ml of a 5% aqueous solution of surfactant (preferably sodium alkylbenzene sulfonate) as a dispersant. The obtained material is added to from 100 ml to 150 ml of the electrolyte.

The electrolyte in which the sample is suspended is subjected to a dispersion treatment using an ultrasonic disperser for 1 minute, and a particle diameter distribution of particles having a particle diameter from 2 μm to 60 μm is measured by a Coulter Multisizer II using an aperture having an aperture diameter of 100 μm. Moreover, 50,000 particles are sampled.

Cumulative distributions by volume are drawn from the side of the smallest diameter with respect to particle diameter ranges (channels) separated based on the measured particle diameter distribution. The particle diameter when the cumulative percentage becomes 16% is defined as a volume average particle diameter D16v, while the particle diameter when the cumulative percentage becomes 50% is defined as a volume average particle diameter D50v. Furthermore, the particle diameter when the cumulative percentage becomes 84% is defined as a volume average particle diameter D84v.

Furthermore, the volume average particle diameter distribution index (GSDv) is calculated as (D84v/D16v)^{1/2}.

The average circularity of powder particles is measured by using a flow-type particle image analyzer “FPIA-3000 (manufactured by Sysmex Corporation)”. Specifically, from 0.1 ml to 0.5 ml of a surfactant (alkylbenzene sulfonate) as a dispersant is added to from 100 ml to 150 ml of water in which solid impurities are removed in advance, and from 0.1 g to 0.5 g of a measurement sample is added thereto. The suspension in which the measurement sample is dispersed is subjected to a dispersion treatment using an ultrasonic disperser for from 1 minute to 3 minutes, and the concentration of the dispersion is made to be from 3,000 particles/μl to 10,000 particles/μl. A measurement of the average circularity of powder particles is performed on the dispersion using a flow-type particle image analyzer.

Here, the average circularity of powder particles is a value obtained by determining the circularity (Ci) of each particle of n particles measured with respect to the powder particles and calculating by the following equation. Here, in the following equation, Ci represents a circularity (=perimeter of a circle equal to the projected area of a particle/perimeter of the particle projected image), and fi represents a frequency of the powder particles.

$$Average circularity ( Ca ) = ( {\sum }_{i = 1}^{n} ( Ci \times fi ) ) / {\sum }_{i = 1}^{n} ( fi ) \qquad Equation 1$$

Specific Inorganic Oxide Particle

The specific inorganic oxide particle in the exemplary embodiment is an inorganic oxide particle containing a silane compound having an amino group.

Inorganic Oxide Particle

Examples of the inorganic oxide particle include particles such as SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂) n, and Al₂O₃.2SiO₂.

Among these, SiO₂, TiO₂, and Al₂O₃ are preferable, and particularly, SiO₂ is more preferable in terms of the function of imparting the fluidity and easiness of controlling the charging properties of the powder particle.

Silane Compound Having Amino Group

The silane compound having an amino group, which is contained in the specific inorganic oxide particle, is a compound containing an amino group and a silicon atom (Si), and is preferably one or more of compounds selected from a silane coupling agent having an amino group and silicone oil having an amino group from the viewpoint of production suitability, the easiness of controlling electrification which is necessary for being applicable to the tribo type, and wide selectivity as a material in the exemplary embodiment.

The silane compound having an amino group may be used alone or in combination of two or more types.

The silane coupling agent having an amino group preferably includes an unsubstituted amino group, an alkyl amino group, or a dialkyl amino group, as the amino group. Here, as the alkyl group in the alkyl amino group and dialkyl amino group, a methyl group, an ethyl group, or a butyl group is preferable.

Specifically, examples of the silane coupling agent having an amino group include 3-aminopropyl trimethoxy silane, 3-aminopropyl methyl dimethoxy silane, 3-aminopropyl triethoxy silane, 3-aminopropyl methyl diethoxy silane, 3-(N,N-dimethyl) aminopropyl trimethoxy silane, 3-(N,N-diethyl) amino propyl trimethoxy silane, 3-(N,N-dibutyl) aminopropyl trimethoxy silane, 3-(N,N-dimethyl) aminopropyl triethoxy silane, 3-(N,N-diethyl)aminopropyltriethoxysilane, 3-(N,N-dibutyl) aminopropyl triethoxy silane, 3-(N,N-dimethyl) aminopropyl methyl dimethoxy silane, 3-(N,N-diethyl) aminopropyl methyl dimethoxy silane, 3-(N,N-dibutyl) aminopropyl methyl dimethoxy silane, N-2-(aminoethyl)-3-aminopropyltrimethoxysilane, N-2-(aminoethyl)-3-aminopropyl methyl dimethoxy silane, N,N-bis (2-hydroxyethyl)-3-aminopropyl triethoxy silane, 3-triethoxysilyl-N-(1,3-dimethyl-butylidene) propylamine, N-phenyl-3-aminopropyl trimethoxy silane, hydrochloride of N-(vinylbenzyl)-2-aminoethyl-3-aminopropyl trimethoxy silane, 1,2-ethane diamine, N-{3-(trimethoxysilyl) propyl}-, N-{(ethenyl phenyl) methyl} derivative hydrochloride, and dimethyl {2-methyl-3-(methylamino) propyl} trimethoxy silane.

Among these, from the viewpoint of charge imparting properties and production of the specific inorganic oxide particle, trimethoxysilane containing the aminopropyl group, dimethoxysilane silane containing the aminopropyl group, triethoxy silane containing the aminopropyl group, and diethoxy silane containing the aminopropyl group are preferable, and particularly, dimethyl {2-methyl-3-(methyl amino) propyl}trimethoxy silane is preferable.

In addition, as an adjusting agent for charge imparting and an adjusting agent for the fluidity, the silane coupling agent containing the amino group may be used in combination of, for example, a silane compound that does not contain the amino group, which is represented by hexamethyl silazane, and a known silane compound such as the silane coupling agent that does not contain the amino group.

In addition, examples of the silicone oil containing the amino group include amino-modified silicone oil to which an organic group containing the amino group is introduced, in at least one of a branched chain and a main chain end of polysiloxane.

Specifically, examples of the organic group containing the amino group, which is to be introduced, include a 2-aminoethyl group, a 3-aminopropyl group, an N-cyclohexyl-3-aminopropyl group, and an N-(2-aminoethyl)-3-aminopropyl group.

The silicone oil having an amino group may be a commercially available product.

Examples of the commercially available product include KF-857, KF-868, KF-865, KF-864, KF-869, KF-859, KF-393, KF-860, KF-880, KF-8004, KF-8002, KF-8005, KF-8010, KF-867, X-22-3820W, KF-869, KF-861, X-22-3939A, and KF-877 which are manufactured by Shin-Etsu Chemical Co., Ltd.

In addition, examples of the commercially available product include BY16-205, FZ-3760, SF8417, BY16-849, BY16-892, FZ-3785, BY16-872, BY16-213, BY16-203, BY16-898, BY16-890, BY16-891, BY16-893, and FZ-3789 which are manufactured by Dow Corning Toray Co., Ltd.

Additionally, examples of the silane compound having an amino group include a compound (a compound that does not contain an alkoxy group) containing an amino group, an alkyl amino group, or a dialkyl amino group, and a silicon atom in addition to the above description.

Examples thereof include aminomethyl trimethyl silane, dimethyl aminodimethyl silane, dimethyl aminotrimethyl silane, bis (dimethyl amino) methyl silane, allyl aminotrimethyl silane, diethyl aminodimethyl silane, bis (ethyl amino) dimethyl silane, his (dimethyl amino) dimethyl silane, 2-aminoethyl aminomethyl trimethyl silane, tris (dimethyl amino) silane, bis (dimethyl amino) methyl vinyl silane, isopropyl aminomethyl trimethyl silane, diethyl aminotrimethyl silane, butyl aminomethyl trimethyl silane, and 3-butyl aminopropyl trimethyl silane.

In the specific inorganic oxide particle, the silane compound having an amino group may be contained in either one of the inside and the surface layer of the inorganic oxide particle, or may be contained in the inside of and on the surface layer thereof.

Due to the easiness of controlling triboelectric series, or a simple preparation process, it is preferable that the silane compound having an amino group is contained in the surface layer of the inorganic oxide particle.

As the method of incorporating the silane compound having an amino group in the inorganic oxide particle, there is a method of adding the silane compound having an amino group in any process of the synthesizing, granulating, or purifying the inorganic oxide particles or the like.

For example, if the inorganic oxide particle is SiO₂, when synthesizing SiO₂ particles (silica particles) through a wet method such as a sol-gel method, the specific inorganic oxide particles containing the silane compound having an amino group in the inside of the particles may be obtained by using the silane compound having an amino group in a reaction process.

In addition, as the method of incorporating the silane compound having an amino group in the surface layer of the inorganic oxide particle, there is a method of chemically bonding or physically adsorbing the silane compound having an amino group on the surface of the inorganic oxide particle.

For example, if the silane compound having an amino group is the silane coupling agent having an amino group, it is possible to obtain the specific inorganic oxide particle containing the silane compound having an amino group in the surface layer by performing the surface treatment with respect to the inorganic oxide particle by using the silane coupling agent having an amino group.

The surface treatment may be performed by immersing the inorganic oxide particle in the surface treatment agent containing the silane compound having an amino group. In addition, the surface treatment may be performed with respect to a dispersion formed of an inorganic oxide particle sol.

The content of the amino group in the specific inorganic oxide particles is changed depending on the molecular weight of the silane compound having an amino group, and may be determined in accordance with a desired control effect of the amount of the electrification, or a desired control effect of the fluidity.

The content of the silane compound having an amino group, for example, with respect to the entire weight of the specific inorganic oxide particles, is preferably from 0.01% by weight to 50% by weight, and is more preferably from 0.1% by weight to 20% by weight from the viewpoints of an effect of controlling the amount of the electrification of the powder particle and the specific inorganic oxide particle, and production suitability.

Meanwhile, the content of the amino group in the specific inorganic oxide particle is estimated by calculating the content of nitrogen atom by using an elemental analysis method with a common device.

Hydrophobizing Agent

As described above, when obtaining the specific inorganic oxide particle by using a method of chemically bonding or physically adsorbing the silane compound having an amino group on the surface of the inorganic oxide particle, components other than the silane compound having an amino group may be used in combination as long as the effect of controlling the triboelectric series is not impaired.

Examples of the components used in combination include a hydrophobizing agent, and the hydrophobizing agent is not particularly limited. Examples thereof include a silane coupling agent other than the silane compound having an amino group, silicone oil other than the silane compound having an amino group, a titanate coupling agent, and an aluminum coupling agent. These may be used alone or in a combination of two or more types.

Preferable Properties of Specific Inorganic Oxide Particle

Volume Average Particle Diameter

The volume average particle diameter D50v of the specific inorganic oxide particles is related to particle diameter of the powder particles, and is preferably from 0.001 μm to 1.0 μm, and more preferably from 0.005 μm to 0.5 μm.

When the volume average particle diameter of the specific inorganic oxide particles is within the above-described range, high fluidity is imparted to the powder particles and thus it is possible to form the coating film which is excellent in smoothness.

Note that, the volume average particle diameter D50v of the specific inorganic oxide particles is measured by using the same method as that used when measuring the volume average particle diameter D50v of the powder coating material.

Content Ratio of Specific Inorganic Oxide Particle

In the exemplary embodiment, based on the carbon content CS of the powder particles and the entire metal content IS of the inorganic oxide particles, the content ratio F of the specific inorganic oxide particles calculated from Equation (1) is preferably equal to or greater than 70%, and more preferably equal to or greater than 80%. In addition, an upper limit of the content ratio is preferably equal to or greater than 95%.

When the content ratio F is equal to or greater than 70%, it is possible to improve the fluidity of the powder particles.

Here, the content ratio F of the specific inorganic oxide particles is calculated by Equation (i) below.

F=100×IS/(IS+CS) Equation (1)

In Equation (1), CS represents the carbon content of the powder particles measured through the fluorescent X-ray analysis, and IS represents the entire metal content of the specific inorganic oxide particles measured through the fluorescent X-ray analysis.

Typically, the main component of the powder particle is a resin, and elements of the resin are mainly formed of carbon.

On the other hand, the inorganic oxide particles in the specific inorganic oxide particles are represented by MOx (M is a metallic element, and x is natural number), and elements of the specific inorganic oxide particles are mainly formed of M.

In addition, the fluorescent X-ray analysis is performed by measuring the constitution ratio of the elements on the surface of the measurement sample to be analyzed is measured.

That is, the content ratio F which is obtained from Equation (1) represents the coverage of the specific inorganic oxide particle on the surface of the powder particle, and even when the oxygen content which is contained in the specific inorganic oxide particle is subtracted, the coverage of the specific inorganic oxide particle is sufficient for improving the fluidity of the powder particle as long as the result of Equation (1) is equal to or greater than 70%.

Measuring Method of CS and IS by Fluorescent X-Ray Analysis

As a sample pretreatment, pressure molding is performed on the powder coating material of 4 g for 1 minute by using a pressure molding device with 10 t (10,000 kg) of pressure.

The obtained measurement sample is measured in a quantitative and qualitative way, for example, under the measurement conditions of an X-ray tube voltage of 60 KV, an X-ray tube current of 50 mA, a measurement time of 40 deg/min by using a scanning fluorescent X-ray analysis device ZSX Primus II manufactured by RIGAKU corporation.

Here, elements to be measured in the specific inorganic oxide particle are Si, Ti, Al, Cu, Zn, Sn, Ce, Fe, Mg, Ba, Ca, K, Na, Zr, and Ca, and IS is the total amount of these elements.

Other External Additives

In the powder coating material according to the exemplary embodiment, the external additives other than the specific inorganic oxide particle may be used in combination as long as the effect of realizing the coating regardless of the coating methods is not impaired.

Examples of other external additives include a known external additive which is used for the powder coating material, such as inorganic particles or those obtained by subjecting the surface of the inorganic particles to a hydrophobizing treatment.

In the case of using the specific inorganic oxide particles and an external additive in combination, the content of the external additives is preferably equal to or less than 1% by weight with respect to the entire content of the specific inorganic oxide particles and the external additive.

Method of Preparing Powder Coating Material

Next, a method of preparing the powder coating material according to the exemplary embodiment will be described.

After preparing the powder particles, the powder coating material according to the exemplary embodiment is obtained by externally adding the specific inorganic oxide particles to the powder particles.

The powder particles may be prepared using any of a dry preparing method (e.g., kneading and pulverizing method) and a wet preparing method (e.g., aggregation and coalescence method, suspension and polymerization method, and dissolution and suspension method). The powder particle preparing method is not particularly limited to these preparing methods, and a known preparing method is employed.

Among these, the powder particles are preferably obtained by an aggregation and coalescence method, in terms of that it is possible to easily control the volume average particle diameter distribution index GSDv, the volume average particle diameter D50v, and the average circularity to be in a preferable range described above.

Hereinafter, an example of the aggregation and coalescence method of preparing the powder particles which are the core/shell particles will be described.

Specifically, the powder particles are preferably prepared by performing: a step of forming first aggregated particles by aggregating first resin particles and a thermosetting agent in dispersion in which the first resin particles containing a thermosetting resin, and the thermosetting agent are dispersed, or by aggregating composite particles in a dispersion in which composite particles containing a thermosetting resin and a thermosetting agent are dispersed (a first aggregated particle forming step); a step of forming second aggregated particles by mixing first aggregated particle dispersion in which the first aggregated particles are dispersed and second resin particle dispersion in which second resin particles containing the resin are dispersed, with each other, aggregating the second resin particles on the surface of the first aggregated particles, and attaching the second resin particles to the surface of the first aggregated particles (a second aggregated particle forming step); and a step of heating second aggregated particle dispersion in which the second aggregated particles are dispersed so as to coalesce the second aggregated particles (a coalesce step).

In the powder particles prepared by this aggregation and coalescence method, a coalesced portion of the first aggregated particles is the core, and the coalesced portion of the second resin particles attached to the surface of the first aggregated particles is the resin coating portion.

For this reason, when the first aggregated particles formed in the first aggregated particle forming step are moved to the coalesce step without undergoing the second aggregated particles forming step, and then are subjected to coalesce instead of the second aggregated particles, it is possible to obtain powder particles having a single-layered structure.

Hereinafter, the respective steps will be described in detail.

In the following description, a method of preparing powder particles containing a colorant will be described, but the colorant is only used if necessary.

Dispersion Preparation Step

First, the dispersion used in the aggregation and coalescence method is prepared.

Specifically, first resin particle dispersion in which first resin particles containing the thermosetting resin of the core are dispersed, thermosetting agent dispersion in which the thermosetting agent is dispersed, colorant dispersion in which the colorant is dispersed, and second resin particle dispersion in which second resin particles containing the resin of the resin coating portion are dispersed, are prepared.

In addition, composite particle dispersion in which the composite particles containing the thermosetting resin and the thermosetting agent of the core are dispersed is prepared, instead of the first resin particle dispersion and the thermosetting agent dispersion.

In the powder coating material preparation step, the first resin particles, the second resin particles, and the composite particles are collectively described as the “resin particles” and the dispersion of the resin particles are described as “resin particle dispersion”.

Herein, resin particle dispersion is, for example, prepared by dispersing the resin particles in a dispersion medium with a surfactant.

An aqueous medium is used, for example, as the dispersion medium used in the resin particle dispersion.

Examples of the aqueous medium include water such as distilled water, ion exchange water, or the like, alcohols, and the like. The medium may be used alone or in combination of two or more types.

Examples of the surfactant include an anionic surfactant such as sulfuric ester salt, sulfonate, phosphate ester, and soap; a cationic surfactant such as amine salt and quaternary ammonium salt; and a nonionic surfactant such as polyethylene glycol, alkyl phenol ethylene oxide adduct, and polyol. Among these, an anionic surfactant and a cationic surfactant are particularly used. The nonionic surfactant may be used in combination with the anionic surfactant or the cationic surfactant.

The surfactants may be used alone or in combination of two or more types thereof.

Regarding the resin particle dispersion, as a method of dispersing the resin particles in the dispersion medium, a common dispersing method using, for example, a rotary shearing-type homogenizer, or a ball mill, a sand mill or a DYNO mill, which each has a media, is exemplified. Depending on the type of the resin particles, the resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (O phase); and converting the resin (so-called phase inversion) from W/O to O/W by adding an aqueous medium (W phase) to form a discontinuous phase, thereby dispersing the resin as particles in the aqueous medium.

A method of preparing the resin particle dispersion will be specifically described below.

In addition, in the case where the resin particle dispersion is a polyester resin particle dispersion in which polyester resin particles are dispersed, after performing heating, melting, and polycondensing a raw material monomer under reduced pressure, a solvent (for example, ethyl, acetate) is added into the obtained polycondensate product so as to dissolve the polycondensate, the obtained solution is stirred while adding a weak alkaline aqueous solution thereto, and subjected to phase inversion emulsification, and accordingly, the polyester resin particle dispersion is obtained.

Meanwhile, when the resin particle dispersion is the composite particle dispersion, the thermosetting resin and the thermosetting agent are mixed with each other, and are dispersed (for example, subjected to emulsification such as phase inversion emulsification) in a dispersion medium, and accordingly the composite particle dispersion is obtained.

The volume average particle diameter of the resin particles dispersed in the resin particle dispersion is, for example, preferably equal to or smaller than 1 μm, more preferably from 0.01 μm to 1 μm, even more preferably from 0.08 μm to 0.8 μm, and still more preferably from 0.1 μm to 0.6 μm.

Regarding the volume average particle diameter of the resin particles, a cumulative distribution by volume is drawn from the side of the smallest diameter with respect to particle diameter ranges (channels) separated using the particle diameter distribution obtained by the measurement of a laser diffraction-type particle diameter distribution measuring device (for example, LA-700 manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

The content of the resin particles contained in the resin particle dispersion is, for example, preferably from 5% by weight to 50% by weight, and more preferably from 10% by weight to 40% by weight.

For example, the thermosetting agent dispersion and the colorant dispersion are also prepared in the same manner as in the case of the resin particle dispersion. That is, the resin particles in the resin particle dispersion are the same as the particles of the colorant dispersed in the colorant dispersion, the particles of the thermosetting agent dispersed in the thermosetting agent dispersion, in terms of the volume average particle diameter, the dispersion medium, the dispersing method, and the content of the particles.

First Aggregated Particle Forming Step

Next, the first resin particle dispersion, the thermosetting agent dispersion, and the colorant dispersion are mixed with each other.

The first resin particles, the thermosetting agent, and the colorant are heterogeneously aggregated in the mixed dispersion, thereby forming first aggregated particles having a diameter near a target powder particle diameter and including the first resin particles, the thermosetting agent, and the colorant.

Specifically, for example, an aggregating agent is added to the mixed dispersion and a pH of the mixed dispersion is adjusted to be acidic (for example, the pH is from 2 to 5). If necessary, a dispersion stabilizer is added. Then, the mixed dispersion is heated at a temperature of a glass transition temperature of the first resin particles (specifically, for example, from a temperature −30° C. of the glass transition temperature to −10° C. of the glass transition temperature of the first resin particles to a temperature) to aggregate the particles dispersed in the mixed dispersion, thereby forming the first aggregated particles.

In the first aggregated particle forming step, the first aggregated particles may be formed by mixing the composite particle dispersion including the thermosetting resin and the thermosetting agent, and the colorant dispersion with each other and heterogeneously aggregating the composite particle and the colorant in the mixed dispersion.

In the first aggregated particle forming step, for example, the aggregating agent may be added at room temperature (for example, 25° C.) while stirring of the mixed dispersion using a rotary shearing-type homogenizer, the pH of the mixed dispersion may be adjusted to be acidic (for example, the pH is from 2 to 5), a dispersion stabilizer may be added if necessary, and the heating may then be performed.

Examples of the aggregating agent include a surfactant having an opposite polarity to the polarity of the surfactant used as the dispersing agent to be added to the mixed dispersion, metal salt, a metal salt polymer, and a metal complex. When a metal complex is used as the aggregating agent, the amount of the surfactant used is reduced and charging characteristics are improved.

After completing the aggregation, an additive for forming a complex or a bond similar to a bond for forming the complex, with the metal ion of the aggregating agent, may be used, if necessary. A chelating agent is suitably used as this additive. With the addition of this chelating agent, the content of the metal ions of the powder particles may be adjusted when the aggregating agent is excessively added.

Herein, the metal salt, the metal salt polymer, or the metal complex as the aggregating agent is used as a supply source of the metal ions. These examples are as described above.

A water-soluble chelating agent is used as the chelating agent. Specific examples of the chelating agent include oxycarboxylic acids such as a tartaric acid, a citric acid, and a gluconic acid, an iminodiacetic acid (IDA), nitrilotriacetic acid (NTA), and an ethylenediaminetetraacetic acid (EDTA).

The amount of the chelating agent added is, for example, preferably from 0.01 parts by weight to 5.0 parts by weight, and more preferably from 0.1 parts by weight to less than 3.0 parts by weight with respect to 100 parts by weight of the resin particles.

Second Aggregated Particle Forming Step

Next, the obtained first aggregated particle dispersion in which the first aggregated particles are dispersed is mixed together with the second resin particle dispersion.

Meanwhile, the second resin particles may be the same or different type with respec to the first resin particles.

The second resin particles are aggregated to be attached to the surface of the first aggregated particles in the mixed dispersion in which the first aggregated particles and the second resin particles are dispersed, thereby forming second aggregated particles in which the second resin particles are attached to the surface of the first aggregated particles.

Specifically, in the first aggregated particle forming step, for example, when the particle diameter of the first aggregated particles reaches a target particle diameter, the second resin particle dispersion is mixed with the first aggregated particle dispersion, and the mixed dispersion is heated at a temperature equal to or lower than the glass transition temperature of the second resin particles.

pH of the mixed dispersion is set to be in a range of 6.5 to 8.5, for example, and therefore the progress of the aggregation is stopped.

Accordingly, the second aggregated particles in which the second resin particles are aggregated to be attached to the surface of the first aggregated particles are obtained.

Coalescence Step

Next, the second aggregated particle dispersion in which the second aggregated particles are dispersed is heated at, for example, a temperature that is equal to or higher than the glass transition temperature of the first and second resin particles (for example, a temperature that is higher than the glass transition temperature of the first and second resin particles by 10° C. to 30° C.) to coalesce the second aggregated particles and form the powder particles.

The powder particles are obtained through the foregoing steps.

Herein, after the coalescence step ends, the powder particles formed in the dispersion are subjected to a washing step, a solid-liquid separation step, and a drying step, that are well known, and thus dry powder particles are obtained.

In the washing step, preferably displacement washing using ion exchange water is sufficiently performed from the viewpoint of charging properties. In addition, the solid-liquid separation step is not particularly limited, but suction filtration, pressure filtration, or the like is preferably performed from the viewpoint of productivity. The method for the drying step is also not particularly limited, but freeze drying, airflow drying, fluidized drying, vibration-type fluidized drying, or the like is preferably performed from the viewpoint of productivity.

The powder coating material according to the exemplary embodiment is prepared by adding and mixing the specific inorganic oxide particles, and other external additives, if necessary, to the obtained dry powder particles.

At this time, the mixing ratio of the powder particles and the specific inorganic oxide particles may be set to be in a range of, for example, the content ratio F described above. For example, the mixing ratio of the specific inorganic oxide particles with respect to the powder particles is preferably from 0.01% by weight to 5% by weight, and more preferably from 0.01% by weight to 2.0% by weight.

The mixing is preferably performed with, for example, a V-blender, a Henschel mixer, a Lodige mixer, or the like.

Furthermore, if necessary, coarse particles of the powder coating material may be removed using a vibration sieving machine, a wind-power sieving machine, or the like.

Coated Article/Method of Preparing a Coated Article

A coated article according to the exemplary embodiment is a coated article having formed on the surface a coating film formed by the powder coating material according to the exemplary embodiment. As a method of preparing the coated article according to the exemplary embodiment, there is a method of preparing the coated article, which performs coating with the powder coating material according to the exemplary embodiment.

Specifically, a coated article is obtained by coating a surface to be coated of an article with the powder coating material, followed by heating (burning) to cure the powder coating material, thereby forming a coating film formed.

The coating of the powder coating material is performed by using a known coating method such as electrostatic powder coating by using the electrification (the corona type) with the corona discharge and the frictional electrification (the tribo type), and fluidized dipping.

The thickness of the coating film of the powder coating material is, for example, preferably from 30 μm to 50 rm.

A heating temperature (burning temperature) is, for example, preferably from 90° C. to 250° C., more preferably from 100° C. to 220° C., and even more preferably from 120° C. to 200° C. The heating time (burning time) is adjusted depending on the heating temperature (burning temperature).

The coating and the heating (burning) of the powder coating material may be simultaneously performed.

A target product to be coated with the powder coating material is not particularly limited, and various metal components, ceramic components, or resin components are used. These target products may be uncompleted products which are not yet molded to the products such as a plate-shaped product or a linear product, and may be molded products which are molded to be used in an electronic component, a road vehicle, or an interior and exterior material of a building. In addition, the target product may be a product including a surface to be coated which is subjected to a surface treatment such as a primer treatment, a plating treatment, or an electrodeposition coating, in advance.

### EXAMPLES

Hereinafter, the exemplary embodiment will be described in detail using Examples, but is not limited to these Examples. In the following description, unless specifically noted, “parts” and “%” are based on the weight.

Preparation of Specific Inorganic Oxide Particle A

The silane coupling agent treatment is performed by adding 30 parts of AEROSIL 300 (the volume average particle diameter of 7.0 nm) manufactured by Nippon Aerosil Co., Ltd. as a silicon dioxide (SiO₂) sol, and 100 parts of methyl isobutyl ketone into a reaction vessel which is equipped with a stirring device, a thermometer, a reflux tube with a Dean-Stark trap, and a dropping funnel, additionally adding 10 parts of dimethyl {2-methyl-3-(methyl amino) propyl} trimethoxy silane thereinto while stirring the mixture, heating the mixture, and then holding the resultant material at a temperature of 80° C. for 8 hours.

Thereafter, the solvent component is distilled off under reduced pressure at a temperature of 40° C. for 1 hour with vacuum degree in a range of 15 mmHg to 20 mmHg, and then continuously distilled off under reduced pressure for 30 minutes by being heated at a temperature of 60° C., and therefore, a silica particle (the specific inorganic oxide particle A), which is subjected to the surface treatment by using the silane coupling agent having an amino group, is obtained.

Preparation of Specific Inorganic Oxide Particle B

A silica particle (the specific inorganic oxide particle B), which is subjected to the surface treatment by using the silicone oil having an amino group, is obtained in the same manner as in the preparation of the specific inorganic oxide particle A described above except that 1.0 part of modified silicone oil KF-857 which is manufactured by Shin-Etsu Chemical Co., Ltd. is used instead of 10 parts of dimethyl {2-methyl-3-(methylamino) propyl} trimethoxy silane which is used in the preparation of the specific inorganic oxide particle A.

Preparation of Specific Inorganic Oxide Particle C

A dimethyl {2-methyl-3-(methyl amino) propyl}trimethoxy silane sol compound is synthesized by adding 200 parts of methanol and 10 parts of dimethyl {2-methyl-3-(methyl amino) propyl}trimethoxy silane into the reaction vessel, which is equipped with the stirring device, the thermometer, the reflux tube with the Dean-Stark trap, and the dropping funnel, adding 1.0 part of aqueous hydrochloric acid solution (1.0 N) while stirring the above materials, and then stirring the resultant at room temperature for 5 hours in a state where the pH is set to be 1.0 to 2.0.

A silica particle (the specific inorganic oxide particle C) containing the silane compound having an amino group in the inside of the particle is obtained by heating a reactive solution at a temperature of 50° C. for 2 hours, vacuum-concentrating the reactive solution, and then drying the reactive solution in a spray-drying device.

Preparation of Specific Inorganic Oxide Particle D

A silica particle (the specific inorganic oxide particle D), which is subjected to the surface treatment by using the silane coupling agent having an amino group, is obtained in the same manner as in the preparation of the specific inorganic oxide particle A described above except that AEROSIL OX-50 (manufactured by Nippon Aerosil Co., Ltd.: the volume average particle diameter of 40 nm) is used instead of AEROSIL 300 which is used in the preparation of the specific inorganic oxide particle A.

Preparation of Specific Inorganic Oxide Particle E

A silica particle (the specific inorganic oxide particle E), which is subjected to the surface treatment by using the silane coupling agent having an amino group, is obtained in the same manner as in the preparation of the specific inorganic oxide particle A described above except that 2-aminoethyl aminomethyl trimethyl silane is used instead of dimethyl {2-methyl-3-(methylamino) propyl} trimethoxy silane which is used in the preparation of the specific inorganic oxide particle A.

Preparation of specific inorganic oxide particle F An alumina particle (the specific inorganic oxide particle F), which is subjected to the surface treatment by using the silane coupling agent having an amino group, is obtained in the same manner as in the preparation of the specific inorganic oxide particle A described above except that AEROXIDE Alu 130 manufactured by Nippon Aerosil Co., Ltd. (the alumina particle) is used instead of AEROSIL 300 which is used in the preparation of the specific inorganic oxide particle A.

Preparation of hydrophobize Inorganic Oxide Particle a

A hydrophobized silica particle: AEROSIL R 9200 (treated with dimethyl dichloro silane) is prepared as a hydrophobized inorganic oxide particle a.

Measurement

The specific inorganic oxide particles A to F which are obtained as described above, and the volume average particle diameter D50v of the hydrophobized inorganic oxide particle a are measured by using the aforementioned method.

The results are shown in Table 1 below.

Preparation of Polyester Resin Particle Dispersion

Composite Dispersion of Polyester Resin and Thermosetting Agent (1)

Preparation of Polyester Resin (PES1)

Polycondensation reaction is performed by adding raw materials of the following compositions into the reaction vessel which is equipped with the stirring device, the thermometer, a nitrogen gas inlet port, and a fractionator and raising a temperature up to 240° C. while stirring the materials under the nitrogen atmosphere.
Terephthalic acid: 742 parts (100 mol %)
Neopentyl glycol: 312 parts (62 mol %)
Ethylene glycol: 59.4 parts (20 mol %)
Glycerin: 90 parts (18 mol %)
Di-n-butyl tin oxide: 0.5 parts

The obtained polymers (the polyester resin (PES1)) has a glass transition temperature of 55° C., an acid value (Av) of 8 mgKOH/g, a hydroxyl value (OHv) of 70 mgKOH/g, a Mw of 26,000, and a Mn of 8,000.

Preparation of Composite Dispersion of Polyester Resin and Thermosetting Agent

While maintaining a jacketed 3-liter reaction vessel (manufactured by Tokyo Rikakikai Co, Ltd.: BJ-30N) which is equipped with a capacitor, the thermometer, a water dripping device, and an anchor blade at 40° C. in a thermostatic water circulating bath, a mixed solvent obtained by mixing 180 parts of ethyl acetate and 80 parts of isopropyl alcohol is added into the reaction vessel, and then the following compositions are added thereinto.
Polyester resin (PES1): 240 parts
Blocked isocyanate thermosetting agent: 60 parts (VESTAGONB 1530 manufactured by Evonik Industries)
Benzoin: 3 parts
Acrylic oligomer (Acronal 4F manufactured by BASF Japan Ltd.): 3 parts

The above components are put into the reaction vessel, and stirred at 150 rpm by using a three-one motor to performdissolutione, thereby preparing an oil phase. To the oil phase which is being stirred, a mixed solution of 1 part of 10% ammonia aqueous solution and 47 parts of 5% sodium hydroxide aqueous solution is added dropwise at a period of 5 minutes, the resultant is mixed for 10 minutes, and then 900 parts of the ion exchange water is added dropwise to the mixture at a rate of 5 parts for every minute so as to perform phase inversion, whereby an emulsion is obtained.

Subsequently, 800 parts of the obtained emulsion and 700 parts of the ion exchange water are put into a 2-liter round-bottom flask, and the mixture is set in an evaporator (manufactured by Tokyo Rikakikai Co, Ltd.) provided with a vacuum control unit via a trap. The round-bottom flask is heated in a hot tub at 60° C. while being rotated, and a solvent is removed by reducing the pressure to 7 kPa with attention so as not to bump up the contents.

The pressure is returned to be a normal pressure when a collected amount of solvents becomes 1,100 parts, and then the round-bottom flask is cooled with water to obtain a dispersion.

The obtained dispersion has no smell of solvent. The resin particle in the dispersion has a median diameter of 150 nm.

Thereafter, an anionic surfactant (manufactured by Dow Chemical Company, Dowfax2A1, an amount of active ingredient: 45%) in an amount of 2% (in terms of the active ingredient) with respect to the amount of the resin is added into the dispersion and mixed, and then the ion exchange water is added thereto to thereby adjust the solid content concentration to 20%.

The Resultant is Referred to as a Composite Dispersion of Polyester Resin and Thermosetting Agent (1).

Polyester Resin Dispersion (2)

The polyester resin dispersion is prepared in the same method as that of preparing the composite dispersion of polyester resin and thermosetting agent (1) except for the amount of the polyester resin (PES1) is set to be 300 parts, and the blocked isocyanate thermosetting agent, benzoin, and acrylic oligomer are not added.

The Resultant is Referred to as the Polyester Resin Dispersion (2).

Colorant Dispersion (K)
Carbon black (Nipex35 manufactured by Orion Engineered Carbons): 50 parts
Anionic surfactant (Neogen R manufactured by Daiichi Kogyo Seiyaku Co., Ltd.): 5 parts
Ion exchange water: 200 parts

The above described materials are mixed and subjected to a dispersion treatment for one hour by using a high pressure impact type dispersing machine ULTIMIZER (HJP30006 manufactured by Sugino Machine, Ltd.) to thereby obtain a colorant dispersion (K). An average particle diameter of colorant particles in the colorant dispersion (K) is 190 nm and the solid content of the colorant dispersion is 20%.

Preparation of Powder Particle (1)
Composite dispersion of polyester resin and thermosetting agent (1): 260 parts
Colorant dispersion (K): 32.7 parts
Cationic surfactant (SANISOL B50 manufactured by Kao Corporation): 1.5 parts
Aluminum polychloride: 0.36 parts
Ion exchange water: 1000 parts

The above materials are accommodated in a round stainless steel flask, are mixed and dispersed using a homogenizer (ULTRA-TURRAX T50 manufactured by IKA Ltd.), and heated to 48° C. while stirring in the flask in the heating oil bath. After holding the resultant material at 48° C. for 30 minutes, formation of the aggregated particles is confirmed by using an optical microscope.

130 parts of the polyester resin dispersion (2) is added to the above resultant. Thereafter, the pH of the liquid is adjusted to 8.0 by using a sodium hydroxide aqueous solution of which concentration is 0.5 mol/L, the flask is air-tightly sealed, the solution is heated to 90° C. while continuously stirring the solution by causing the sealing of the stirring shaft to be magnetically performed, and is further maintained for 3 hours.

After completing the reaction, the solution in the flask is cooled, and then the solid-liquid separation is performed by Nutsche-type suction filtration. The solid content is redispersed in 1000 parts of ion exchange water at 30° C. and is stirred by means of a stirring blade at 300 rpm for 15 minutes, and then the solid-liquid separation is performed by the Nutsche-type suction filtration. The redispersion and the suction filtration are repeatedly performed, and the washing is completed when electric conductivity of the filtrate is equal to or less than 10.0 S/cmt.

Next, the resultant is put into a vacuum dryer and continuously dried for 12 hours, thereby obtaining the powder particle (1).

The powder particle (1) is the core/shell type resin particle, and the volume average particle diameter D50v thereof is 5.8 μm.

Preparation of Powder Particle (2)

The powder particle (2) is obtained in the same way described above except that the composite dispersion of polyester resin and thermosetting agent (1) is set to be 400 parts, and 100 parts of the polyester resin dispersion (2) is not added when preparing the powder particle (1).

The powder particle (2) is a particle having a single-layered structure, and when the particle diameter thereof is measured by using a Coulter Counter, the volume average particle diameter D50v is 6.5 μm and the volume average particle diameter distribution index GSDv is 1.30. The average circularity of powder particles measured by using a flow-type particle image analyzer “FPIA-1000 (manufactured by Sysmex Corporation) is 0.98, which means an approximately spherical shape.

### Example 1

### Preparation of Powder Coating Material (1)

A powder coating material (1) is obtained by mixing 0.8 parts of the specific inorganic oxide particle A with respect to 100 parts of the obtained powder particles (1) as an external additive.

### Example 2

A powder coating material (2) is obtained by mixing 0.8 parts of the specific inorganic oxide particle B with respect to 100 parts of the obtained powder particles (1) as an external additive.

### Example 3

A powder coating material (3) is obtained by mixing 1.0 part of the specific inorganic oxide particle C with respect to 100 parts of the obtained powder particles (1) as an external additive.

### Example 4

A powder coating material (4) is obtained by mixing 1.5 parts of specific inorganic oxide particle D as an external additive with respect to 100 parts of the obtained powder particles (1).

### Example 5

A powder coating material (5) is obtained by mixing 0.8 parts of the specific inorganic oxide particle E with respect to 100 parts of the obtained powder particles (1) as an external additive.

### Example 6

A powder coating material (6) is obtained by mixing 0.6 parts of the specific inorganic oxide particle F with respect to 100 parts of the obtained powder particles (1) as an external additive.

### Example 7

A powder coating material (7) is obtained by mixing 0.72 parts of the specific inorganic oxide particle A with respect to 100 parts of the obtained powder particles (1) as an external additive.

### Example 8

A powder coating material (8) is obtained by mixing 0.68 parts of the specific inorganic oxide particle A with respect to 100 parts of the obtained powder particles (1) as an external additive.

### Example 9

A powder coating material (9) is obtained by mixing 0.6 parts of the specific inorganic oxide particle A with respect to 100 parts of the obtained powder particles (2) as an external additive.

### Comparative Example 1

A powder coating material (Ci) is obtained by mixing 0.8 parts of the hydrophobized inorganic oxide particle a with respect to 100 parts of the obtained powder particles (1) as an external additive.

Measurement

The fluorescent X-ray analysis is performed with respect to the obtained powder coating material in Examples in the above described method so as to calculate the content ratio F by Equation (1) as described above.

The results are shown in Table 1.

Evaluation

Evaluation of Fluidity

The fluidity of the obtained powder coating material in Examples is evaluated as follows.

The fluidity of the obtained powder coating material is evaluated by measuring an angle of repose. A powder tester PT-X which is manufactured by Hosokawa Micron Corporation is used in the evaluation, and evaluation criteria areas follows.

The results are shown in Table 1.

Evaluation Criteria

G1: an angle of repose is equal to or less than 30°.

G2: an angle of repose is greater than 30° and equal to or less than 400°.

G3: an angle of repose is greater than 40°.

Evaluation of Availability of Coating and Smoothness of Coating Film

Availability of Coating

The coating of the powder coating materials obtained from the respective Examples is performed by using two devices of a corona-type electrostatic coating device (XH4-110C manufactured by Asahi Sunac Corporation) and a tribo type electrostatic coating device (MTR100VT-mini manufactured by Asahi Sunac Corporation).

A test panel of ZINC phosphate treated steel plate is used as a material to be coated.

The availability of the coating is determined with reference to the following evaluation criteria.

Evaluation Criteria

G1: coating is able to be performed, and smoothness of formed coating film (before burning) has no problem.

G2: coating is able to be performed, but level of smoothness of formed coating film (before burning) is slightly low.

G3: coating is not able to be performed.

Smoothness of Coating Film

The coated test panel of ZINC phosphate treated steel plate is heated (burned) at a heating temperature of 180° C. for a heating time of 1 hour, and a coating film sample having the thickness of 30 μm is obtained.

The center line average roughness (hereinafter, referred to as “Ra”, unit: μm) of the surface of the coating film sample is measured by using a surface roughness measuring instrument (SURFCOM 1400A manufactured by Tokyo Seimitsu Co., Ltd.).

Evaluation criteria are as follows. Evaluation results of the samples are shown in Table 1. In Table 1, “-” represents that the smoothness is not measured.

G1: Ra is equal to or less than 0.4 μm.

G2: Ra is greater than 0.4 μm and equal to or less than 0.5 μm.

G3: Ra is greater than 0.5 μm.

TABLE 1

| | Powder particle | | | Inorganic oxide particle | | | | | Evaluation | | | | |
|---|---|---|---|---|---|---|---|---|---|---|---|---|---|
| | | | Volume | | Silane | Volume | | | | Availability | | Smoothness | |
| | | | average | | compound | average | | | | of | | in coating | |
| | | | particle | | having | particle | Content* | | | coating | | film | |
| | | | diameter | | amino | diameter | (weight | Content | | Corona | Tribo | Corona | Tribo |
| | No. | Form | (nm) | No. | group | (nm) | %) | ratio F | Fluidity | type | type | type | type |
| Example 1 | (1) | Core/shell | 5.8 | A | Contained | 8.0 | 0.8 | 79.6 | G1 | G1 | G1 | G1 | G1 |
| Example 2 | (1) | Core/shell | 5.8 | B | Contained | 8.0 | 0.8 | 79.6 | G1 | G1 | G1 | G1 | G1 |
| Example 3 | (1) | Core/shell | 5.8 | C | Contained | 50 | 1.0 | 79.6 | G2 | G1 | G1 | G2 | G1 |
| Example 4 | (1) | Core/shell | 5.8 | D | Contained | 40 | 1.5 | 99.5 | G2 | G1 | G1 | G2 | G1 |
| Example 5 | (1) | Core/shell | 5.8 | E | Contained | 8.0 | 0.8 | 79.6 | G1 | G1 | G1 | G1 | G1 |
| Example 6 | (1) | Core/shell | 5.8 | F | Contained | 8.0 | 0.6 | 95.9 | G1 | G1 | G1 | G1 | G1 |
| Example 7 | (1) | Core/shell | 5.8 | A | Contained | 8.0 | 0.72 | 72.2 | G2 | G1 | G1 | G2 | G1 |
| Example 8 | (1) | Core/shell | 5.8 | A | Contained | 8.0 | 0.68 | 68.5 | G2 | G1 | G2 | G2 | G2 |
| Example 9 | (2) | Single-layered | 6.5 | A | Contained | 8.0 | 0.6 | 79.6 | G2 | G1 | G2 | G2 | G1 |
| | | structure | | | | | | | | | | | |
| Comparative | (1) | Core/shell | 5.8 | a | Not contained | 10.0 | 0.8 | 79.6 | G1 | G1 | G3 | G2 | — |
| Example 1 | | | | | | | | | | | | | |

Content*: amount of inorganic oxide particles with respect to powder particles

As shown in Table 1, unlike the Comparative Examples, in the Examples, it is possible to perform electrostatic coating by using both of the corona type electrostatic coating device and the tribo type electrostatic coating device.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A thermosetting powder coating material comprising:
powder particles containing a thermosetting resin and a thermosetting agent; and
inorganic oxide particles containing a silane compound having an amino group.

2. The thermosetting powder coating material according to claim 1,
wherein the silane compound having an amino group is at least one compound selected from a silane coupling agent having an amino group and silicone oil having an amino group.

3. The thermosetting powder coating material according to claim 2,
wherein the silane compound having an amino group contains at least one amino group selected from the group consisting of a 2-aminoethyl group, a 3-aminopropyl group, an N-cyclohexyl-3-aminopropyl group, and an N-(2-aminoethyl)-3-aminopropyl group.

4. The thermosetting powder coating material according to claim 2,
wherein the silicone oil having an amino group is an amino-modified silicone oil having an organic group containing the amino group which is introduced into at least one of a branched chain and a main chain end.

5. The thermosetting powder coating material according to claim 1,
wherein a volume average particle diameter D50v of the inorganic oxide particles is from 0.001 μm to 1.0 μm.

6. The thermosetting powder coating material according to claim 1,
wherein the thermosetting resin is a thermosetting polyester resin.

7. The thermosetting powder coating material according to claim 6,
wherein the thermosetting polyester resin has a sum of an acid value and a hydroxyl value of 10 mgKOH/g to 250 mgKOH/g.

8. The thermosetting powder coating material according to claim 6,
wherein a number average molecular weight of the thermosetting polyester resin is from 1,000 to 100,000.

9. The thermosetting powder coating material according to claim 6,
wherein a content of the thermosetting polyester resin is from 20% by weight to 99% by weight with respect to the entirety of the powder particles.

10. The thermosetting powder coating material according to claim 1,
wherein based on a carbon content CS of the powder particle and the entire metal content IS of the inorganic oxide particle which are obtained by fluorescent X-ray analysis, a content ratio F which is calculated from the following Equation (1) is equal to or greater than 70%:
F=100×IS/(IS+CS). Equation (1)

11. The thermosetting powder coating material according to claim 1,
wherein a content of the thermosetting agent is from 1% by weight to 30% by weight with respect to the thermosetting resin.

12. The thermosetting powder coating material according to claim 1,
wherein the powder particles contain a di- or higher-valent metal ion.

13. The thermosetting powder coating material according to claim 12,
wherein the di- or higher valent metal ion is at least one metal ion selected from the group consisting of an aluminum ion, a magnesium ion, an iron ion, a zinc ion, and a calcium ion.

14. The thermosetting powder coating material according to claim 12,
wherein a content of the metal ion is from 0.002% by weight to 0.2% by weight with respect to the entirety of the powder particles.

15. The thermosetting powder coating material according to claim 1,
wherein the powder particles include a core/shell type particle including a core containing the thermosetting resin and the thermosetting agent, and a resin coating portion which coats a surface of the core.

16. The thermosetting powder coating material according to claim 15,
wherein a coverage of the resin coating portion is from 30% to 100%.

17. The thermosetting powder coating material according to claim 15,
wherein a thickness of the resin coating portion is from 0.2 μm to 4 μm.

18. The thermosetting powder coating material according to claim 1,
wherein a volume average particle diameter distribution index GSDv is equal to or less than 1.50.

19. The thermosetting powder coating material according to claim 1,
wherein average circularity is equal to or greater than 0.96.

20. A coated article comprising a coating film formed on a surface of a material to be coated, by the thermosetting powder coating material according to claim 1.
